(19) United States
(12) Patent Application Publication
(10) Pub. No.: US 2002/0138702 A1
(43) Pub. Date: Sep. 26, 2002

(54) Using non-executable memory as executable memory

(76) Inventors: Moshe Gefen, Modiin (IL); Shuka Zernovizky, Tel-Aviv, IL (US)

Correspondence Address: DR. MARK FRIEDMAN LTD., c/o BILL POLKINGHORN DISCOVERY DISPATCH, 9003 FLORIN WAY, UPPER MARLBORO, MD, 20772, US

(21) Appl. No.: 09/816,459

(22) Filed: Mar. 26, 2001

(51) Int. Cl. G06F 12/00

(52) U.S. Cl. 711/154

(57) ABSTRACT

According to the present invention, there is provided a system for enabling code execution from a Non-executable memory. The present invention combines a small amount of an executable memory with a large amount of non-executable memory, in order to enable a highly efficient executable data and code storage system, comprised of relatively cheap non-executable memory components.

### FIELD AND BACKGROUND OF THE INVENTION

### BACKGROUND OF THE INVENTION

1. Field of the Invention

The present invention relates to a system for using Non-executable memory as an executable memory.

2. Description of the Related Art

One of the ways to classify different types of memories is by their ability to directly execute code. The ability to execute code directly from a memory device usually requires the following characteristics from the memory device:

1. Standard memory interface, which includes address bus, data bus and a few more control signals (read enable, write enable etc.). The executing entity (CPU, controller, etc.) determines the address of the required code (by providing the signals of the address bus), executes a given cycle (by providing the required control signals) and expects that the required code will appear on the data bus after a short period of time (ranges from a few nS to a few hundred nS).

2. Full visibility of the whole memory space of the memory device. This means that the executing entity can change the address values to any valid state (within the memory space of the device) and still get the required code after the same period of delay. This behavior is also known as Random Access ability.

Memory devices, which do not have the above characteristics, cannot be used as executable memories. The requirement for a full visibility of the whole memory space actually dictates the internal architecture of the memory devices, and requires that each memory cell will be directly accessed by the host system without any delay. The said architecture requires a large amount of routing signals within the device. These routing signals occupy silicon space and hence make the device more expensive. The accepted opinion in the industry is that the requirement for Random Access of the memory devices leads to a more expensive device.

An example of a memory device that is not executable is NAND flash memory. This device was developed for purposes other than code execution, such as for data storage applications. The fact that the NAND flash is not required to execute code directly enables the use of a different type of internal architecture. The NAND flash architecture does not allow a direct access (a Random Access) to each location, and instead offers a more complex interface to the memory cells. This architecture requires less routing resources (than the amount required in the executable memories) and benefits from a lower cost (per bit). However its chief limitation, as mentioned, is that it is non-executable.

There is thus a widely recognized need for, and it would be highly advantageous to have, a system that can enable non-executable memory, such as NAND flash, to be used as executable memory.

The present invention provides a system and method of enabling code execution from a Non-executable memory (like NAND flash memory). Implementation of the present invention enables the use of low cost memory components in applications where a more costly solution (executable memory) is usually required.

### SUMMARY OF THE INVENTION

According to the present invention, there is provided a system for enabling code execution from a non-executable memory. The present invention combines a small amount of an executable memory with a large amount of non-executable memory, in order to enable a highly efficient executable data storage system, comprised of relatively cheap non-executable memory components.

For example, the implementation can include an 8 MB NAND flash (non-executable) and 1 KB of SRAM (executable). The additional SRAM is negligible (cost wise) but as it is further detailed, it enables execution from all of the 8 MB NAND flash. These numbers are only an example and will be used throughout this document. Any other combinations can be considered and implemented based on the exact requirements.

The present invention provides for the creation of a memory system, whereby there is a low cost for the components (non-executable memory), and a high functioning usually enjoyed by much more expensive components (executable memory). The mechanism of the present invention requires that:

1. The device supports a small amount of fully mapped memory (Random Access) with full visibility to the host system (the executing entity).

2. The device manages algorithms to guarantee availability of the requested information in the executable buffer/buffers.

3. The device supplies a busy signal in cases when the information is not yet available.

According to the preferred embodiment of the present invention: At any given time, the Random Access memory (e.g. 1 KB of SRAM) contains an equal size of memory capacity (e.g. 1 KB) from the non-executable array (e.g. a small portion out of the total NAND capacity, such as 8 MB). According to this example, the 1 KB of SRAM (which reflects a 1 KB of the NAND) operates as executable, and satisfies the requirements of an executable memory (Random Access and standard memory interface). The CPU can execute any location within the range of the SRAM contents.

According to an additional preferred embodiment of the present invention, there is provided a plurality of memory buffers, in order to enable simultaneous downloading of data from non-executable to executable memory, and processing of further data or code requests.

### BRIEF DESCRIPTION OF THE DRAWINGS

The invention is herein described, by way of example only, with reference to the accompanying drawings, wherein:

FIG. 1 is an illustration of the components of the memory system according to the present invention.

FIG. 2 is an illustration of the process, according to the present invention, whereby one or more executable memory buffers are provided, and a busy signal, in order to guarantee availability of requested data in the executable buffer/s.

### DESCRIPTION OF THE PREFERRED EMBODIMENT

The present invention relates to a processing improvement in an executable memory system. More specifically, the present invention provides a system and method for enabling the execution of code from a non-executable memory.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The present invention is a system and method that provide for the enabling of non-executable memory to function as executable memory. This system entails use of a small amount of executable memory in addition to a larger amount of non-executable memory, such that the larger amount of non-executable memory can function as executable memory.

For example, the implementation of a memory system according to the present invention can include an 8 MB NAND flash (non-executable) component and a 1 KB SRAM (executable) component. The additional SRAM is negligible (cost wise) but as it is further detailed, it enables execution from all the 8 MB NAND flash. These numbers are only an example, but for the sake of consistency will be used throughout this document. Any other combinations can be considered and implemented based on the exact requirements. The present invention thus enables creating a system based on paying for low cost, non-executable components, and utilizing the high functionality of executable memory.

The principles and operation of a system and a method according to the present invention may be better understood with reference to the drawings and the accompanying description, it being understood that these drawings are given for illustrative purposes only and are not meant to be limiting, wherein: The present invention includes the following components:

1. An executing entity, such as a CPU, controller etc. for executing code;

2. A non-executable memory component, for storing system code and data;

3. An executable memory component, for acting as a memory buffer for code execution, such that the executable memory component includes within it a portion of the non-executable memory component contents, for emulating the executable memory component, and enabling the downloading of requested data from the non-executable memory component, to the executable memory component.

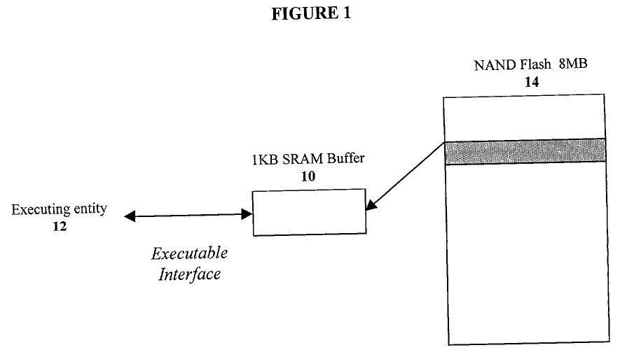

FIG. 1 illustrates an example of the basic system components and the workflow of the present invention. According to FIG. 1, there is provided an executing entity 12, such as a CPU, controller etc., for executing code and processing data. There is further provided a non-executable memory component 14 for storing system code and data. Examples of such a non-executable memory component are NAND flash memory, serial EEPROM AND Flash memory etc. The final primary component of the present invention is a small amount of fully mapped executable memory 10 (Random Access). This executable memory acts as a buffer for the purpose of code execution, and is configured to have full visibility of a host system (the executing entity 12). Examples of this type of memory include SRAM, NOR Flash, etc. This executable memory component 10 includes within it a portion of the non-executable memory component contents 14, equal or smaller in size to the executable memory component, for emulating the executable memory component, and enabling the downloading of requested data from the non-executable memory component 14, to the executable memory component 10.

According to the preferred embodiment of the present invention, as illustrated by the above example, the following requirements must be met:

1. The 1 KB of SRAM is executable and satisfies the requirements of an executable memory (Random Access and standard memory interface). A CPU or executing entity 12 can therefore execute any location within the range of the SRAM 10. According to the present invention, at any given time, the 1 KB of SRAM 10 contains up to 1 KB from the NAND flash array 14 (out of the 8 MB of the total NAND capacity). Data from the NAND flash array 14 is downloaded into the SRAM 10, such that the data inside the SRAM 10 is a copy of a portion of the NAND flash 14 content. In this way, the SRAM 10 functionality is emulated for the NAND 12 content, which enables the NAND 12 content within the SRAM 10 to “become” executable.

2. Until this stage, only a small portion (1 KB) of the NAND flash is executable. It is therefore required to provide a mechanism to enable the control of the 1 KB SRAM buffer in a way that it would be able to contain any of the NAND flash 14 contents according to the executing entity's 12 requirements.

3. In order to enable proper control over the SRAM buffer 10 contents, the implementation includes download online algorithms, for enabling fast downloading of data from the NAND flash to the SRAM buffer as well as for guaranteeing the availability of the requested information in the executable buffer/s. Many types of download algorithms can be used. An example of a very basic and simple one is described here:

i. Making a query to the executable memory, as to the location of requested data/address.

ii. As long as the requested address (requested by the executing entity 12) is included in the current SRAM buffer contents, the device will satisfy the required code immediately, from the buffer, and will not impose any content changes.

iii. When the requested address is not contained within the current SRAM buffer contents, the download algorithms initiate a download operation from the required location of the NAND flash 14 to the SRAM buffer 10. Upon completion of the download operation, the required information is available in an executable manner inside the SRAM buffer 10.

iv. The device of the present invention manages at least one algorithm to guarantee availability of the requested information in the executable buffer/buffers. The device supplies a busy signal in cases when the information is not yet available. For example, in cases when the required data (according to the data address) is not within the SRAM current range, the data must be downloaded from the NAND to the SRAM. This operation takes time (download latency), during which the required addresses cannot return the required code (the required content). The provided busy signal therefore alerts the host system to cause the host system to cease data requests until downloading of the data is complete.

It can be seen that the above download algorithm, or instruction, can satisfy the requirement for full visibility of the NAND flash contents in an executable manner. It should be noted that it is not a true full visibility at all times, since during the download procedure, the memory is not available for execution at all.

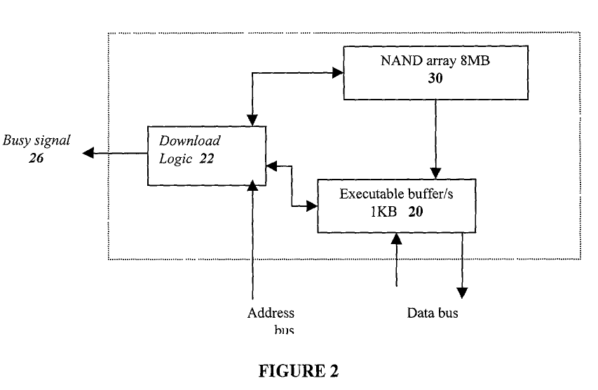

According to a further preferred embodiment of the present invention, the suggested download algorithm, or set of instructions, and system architecture can be easily enhanced to have a better functionality. For example, the suggested architecture, as can be seen in FIG. 2, involves time slots when the memory is not available for execution with the required code. In these cases, while the memory device is in the process of downloading the required code for execution, it is required to supply a “busy signal” 26 to the executing entity 30 in order to notify that the required code is not yet available. The executing entity 30 should use the “busy signal” 26 in order to hold off the execution attempt until the memory device is ready and able to supply the required code. There are many prior art platform-dependant methods of holding off an execution attempt.

A further preferred embodiment of the present invention describes a dual or multiple SRAM buffer 20. This buffer, or set of buffers, as can be seen in FIG. 2 can be used in order to prevent the memory from being locked for accesses during download operations. In this case the download operation will load the requested content to one SRAM buffer, referred to as download logic 22, while the other SRAM buffer 20 remains accessible and executable. The executable buffer 20 can be expanded to include two or more executable buffers. In this case, with proper support of the download state machine, it is possible to support code execution from one or more buffers, while simultaneously modifying the contents of one or more other buffers. This application shortens the BUSY latency, and substantially improves read/write performance. This buffer may also be referred to as a dual buffer (in the case of two buffers) or multiple buffer.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A system for enabling code execution from non executable memory, comprising:
i. An executing entity, for executing code for a host system;
ii. A non-executable memory component, for storing system code and data; and.
iii. An executable memory component, for operating as a memory buffer for executing said code, such that a portion of contents of said non-executable memory component is located within said executable memory component, and said portion of contents of said non-executable memory component emulates executable functions of said executable memory component.

2. The system of claim 1, wherein said executable memory component employs a downloading mechanism for downloading requested data from said non-executable memory component to said executable memory component, such that data addresses requested by said executing entity are downloaded to said executable memory component.

3. The system of claim 1, wherein said non-executable memory component is selected from the group consisting of NAND flash components, serial EEPROM and flash memory components, such that said non-executable memory component functions as an executable memory.

4. A system for executing code using non-executable memory, comprising:
i. An executing entity, for executing code;
ii. A non-executable memory component, for storing said code and data; and.
iii. A plurality of executable memory components that operate as multiple memory buffers for preventing memory lockage for accesses to said data during download operations of said code.

5. The system of claim 4, wherein each of said plurality of memory buffers include download logic and memory buffer space.

6. A method for executing code using non-executable memory, comprising the steps of:
i. providing executable memory, for buffering at least one code request from an executing entity;
ii. providing a non-executable memory, for storing executable code;
iii. downloading at least a portion of said executable code to said executable memory, for emulating executable functions of said executable memory;
iv. executing at least one said code request from said executable memory; and
v. buffering an execution of contents of said non-executable memory in said executable memory.

7. The method of claim 6, further comprising the steps of:
a) managing at least one set of instructions to guarantee availability of said contents in an executable buffer; and
b) supplying a busy signal in cases where said contents are not available, such that the executable entity delays the read cycle until said contents are available.

8. The method of claim 6, wherein said downloading at least a portion of said executable code includes the steps of:
(a) querying said executable memory for data; and
(b) when queried address of said data is only available in non-executable memory, initiating a download operation from a required location of said non-executable memory, to a buffer area of said executable memory.

9. The method of claim 6, such that step iv further includes:
I. providing a plurality of executable memory buffers for preventing said portion of said non-executable memory from being locked for accesses during said downloading operation;
II. loading said executable code to one of said plurality of executable memory buffers; and
III. maintaining at least one of additional said executable memory buffers, to be accessible to said host system and executable by said host system.
